(19) United States
(12) Patent Application Publication
(10) Pub. No.: US 2015/0347970 A1
(43) Pub. Date: Dec. 3, 2015

(54) BETA TESTING DISTRIBUTION

(71) Applicant: APPLE INC., Cupertino, CA (US)

(72) Inventors: Latika Kirtane, San Francisco, CA (US); Ricardo D. Cortes, Los Gatos, CA (US); Jason R. Fosback, Seattle, WA (US); David A. Van Tassell, San Jose, CA (US); David Makower, Milpitas, CA (US); Zachary T. Friedland, San Francisco, CA (US); Daniel H. Miao, River Edge, NJ (US)

(73) Assignee: APPLE INC., Cupertino, CA (US)

(21) Appl. No.: 14/292,652

(22) Filed: May 30, 2014

(51) Int. Cl. G06Q 10/10; G06F 9/445

(52) U.S. Cl. CPC G06Q 10/101; G06F 8/60

(57) ABSTRACT

Systems and methods for testing application programs prior to production that enables the developer to internally test and beta test an application program. Furthermore, a potential tester may be added to a beta test list without providing information specific to a device or account information. Specifically, a tester may provide the developer with any contact information that allows the user to receive a beta test invitation. The beta test invitation may include a link that opens a beta testing application that allows the tester to enter account information that is sent to an organization that distributes the application program without sharing such information with the developer. The distributing organization then may create a provisioning profile that pairs the device with the tested application. Thus, the developer may add external testers even when the external testers do not want to share personal account information or have the ability to share device identification information with the developer.

### BACKGROUND

The present disclosure relates generally to application program reviewing and testing application programs.

This section is intended to introduce the reader to various aspects of art that may be related to various aspects of the present disclosure, which are described and/or claimed below. The background information discussed herein should provide the reader with a better understanding of various aspects of the present disclosure. Accordingly, it should be understood that these statements are to be read in this light, and not as admissions of prior art.

Application programs continue to become prevalent. Application programs provide numerous functions and features. However, developers may want to test for errors, issues, or consumer response to design before the application program reaches production. Thus, developers may test the applications internally, but the developers may also wish to include external testers. However, external testers may lack technical sophistication to enable to external testers to provide information specific to their electronic devices to pair their devices with the tested application program.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to techniques for testing application programs prior to production that enables the developer to internally test and beta test an application program. Furthermore, a potential tester may be added to a beta test list without providing information specific to a device or account information. Specifically, a tester may provide the developer with any contact information that allows the user to receive a beta test invitation. The beta test invitation may include a link that opens a beta testing application that allows the tester to enter account information that is sent to an organization that distributes the application program without sharing such information with the developer. The distributing organization then may create a provisioning profile that pairs the device with the tested application. Thus, the developer may add external testers even when the external testers do not want to share personal account information or have the ability to share device identification information with the developer.

### BRIEF DESCRIPTION OF THE DRAWINGS

Various aspects of this disclosure may be better understood upon reading the following detailed description and upon reference to the drawings in which:

FIG. 1 is a block diagram of an electronic device that may use the techniques disclosed herein, in accordance with an embodiment;

FIG. 2 is a front view of a handheld device, such as an iPhone® by Apple Inc. that may use the techniques disclosed herein, representing an example of the electronic device of FIG. 1, in accordance with an embodiment;

FIG. 3 is a front view of a tablet device, such as an iPad® by Apple Inc. that may use the techniques disclosed herein, representing an example of the electronic device of FIG. 1, in accordance with an embodiment;

FIG. 4 is a perspective view of a notebook computer, such as a MacBook Pro® by Apple Inc. that may use the techniques disclosed herein, representing an example of the electronic device of FIG. 1, in accordance with an embodiment;

FIG. 5 illustrates an interconnection between electronic devices, such as the electronic devices of FIGS. 2-4, in accordance with an embodiment;

FIG. 6 illustrates a flow chart view of a process that may be executed by a developers electronic device when uploading and testing a build of application program, in accordance with an embodiment;

FIG. 7 illustrates a screen that the electronic device may present to a developer for performing the process of FIG. 6, in accordance with an embodiment;

FIG. 8 an internal testers screen that the electronic device may present to a developer for performing the process of FIG. 6, in accordance with an embodiment;

FIG. 9 illustrates an internal testers screen after a build has been uploaded and internal testers have been added, in accordance with an embodiment;

FIG. 10 illustrates an internal testers screen after an application program build has been uploaded and internal testers have been invited, in accordance with an embodiment;

FIG. 11 illustrates a starting beta testing screen may be displayed that the electronic device may display to enable a developer to enter information about the application to be tested, in accordance with an embodiment;

FIG. 12 illustrates a beta testers addition screen that may be used to add beta testers to an application program, in accordance with an embodiment;

FIG. 13 illustrates beta testers addition screen of FIG. 12 with beta testers input into the screen, in accordance with an embodiment;

FIG. 14 illustrates a beta testers added screen that reflects that beta testers have been added, in accordance with an embodiment;

FIG. 15 illustrates quick summary screen of a beta application build that may be presented by the electronic device, in accordance with an embodiment;

FIG. 16 illustrates a quick summary screen for at two builds of a beta application, in accordance with an embodiment;

FIG. 17 illustrates an email notification that informs a developer that a tester has left beta testing, in accordance with an embodiment;

FIG. 18 illustrates an email notification that informs a developer of an addition of beta testers, in accordance with an embodiment;

FIG. 19 illustrates a process that may be performed by an electronic device of a potential beta tester, in accordance with an embodiment;

FIG. 20 illustrates an email invitation to beta test a program application, in accordance with an embodiment;

FIG. 21 illustrates an account credential request from a beta testing application, in accordance with an embodiment;

FIG. 22 illustrates a display of supplemental information by the beta testing application prior to beta testing, in accordance with an embodiment;

FIG. 23 illustrates a screen that informs a user that the user is not currently registered for any beta tests, in accordance with an embodiment;

FIG. 24 illustrates a notification informing a potential tester that the user does not have proper hardware for the beta test, in accordance with an embodiment;

FIG. 25 illustrates a screen summarizing potential beta tested applications for the tester, in accordance with an embodiment;

FIG. 26 illustrates a description page with which a tester may review information about the beta tested application and provide feedback to the developer, in accordance with an embodiment;

FIG. 27 illustrates a device management screen that a tester may use to manage devices registered to beta test an application program, in accordance with an embodiment; and

FIG. 28 illustrates a process that may be performed using one or more servers for associating beta testers with an application program and tracking beta tests, in accordance with an embodiment.

### DETAILED DESCRIPTION OF SPECIFIC EMBODIMENTS

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure generally relates to techniques for testing application programs prior to production that enables the developer to internally test and beta test an application program. Furthermore, the developer may add a potential tester a beta test list without the tester providing device-specific information or account information. Specifically, a tester may provide the developer with any contact information that allows the user to receive a beta test invitation. The beta test invitation may include a link that opens a beta testing application that allows the tester to enter account information that is sent to an organization that distributes the application program without sharing such information with the developer. The distributing organization then may create a provisioning profile that pairs the device with the tested application.

Using the provisioning profile, the tester may install a beta tested version of the application using a sandboxed beta account that the distributing organization has linked to the device and the tester's account (e.g., a production account) corresponding to the information sent to the distributing organization. In some scenarios, the sandboxed beta account may be used to “purchase” applications or in-app purchases without the costs that would be associated with the same purchases using the production account. Therefore, the beta tested application may be fully tested using a sandbox environment so that even purchased features may be fully beta tested.

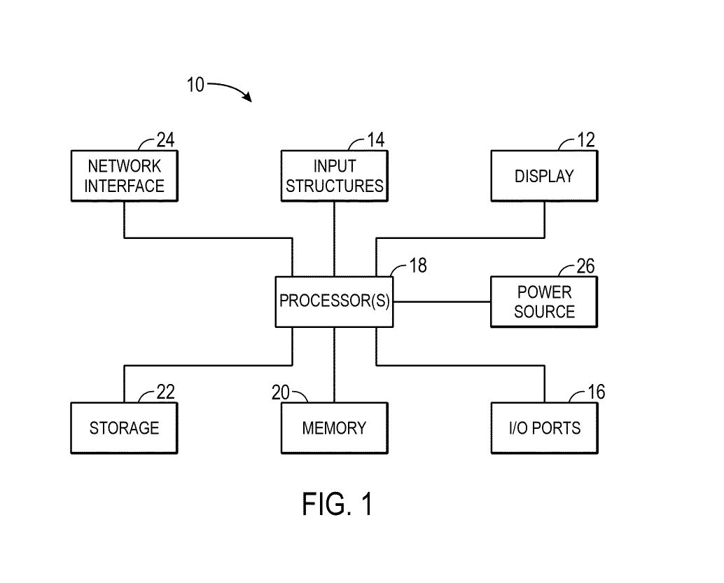

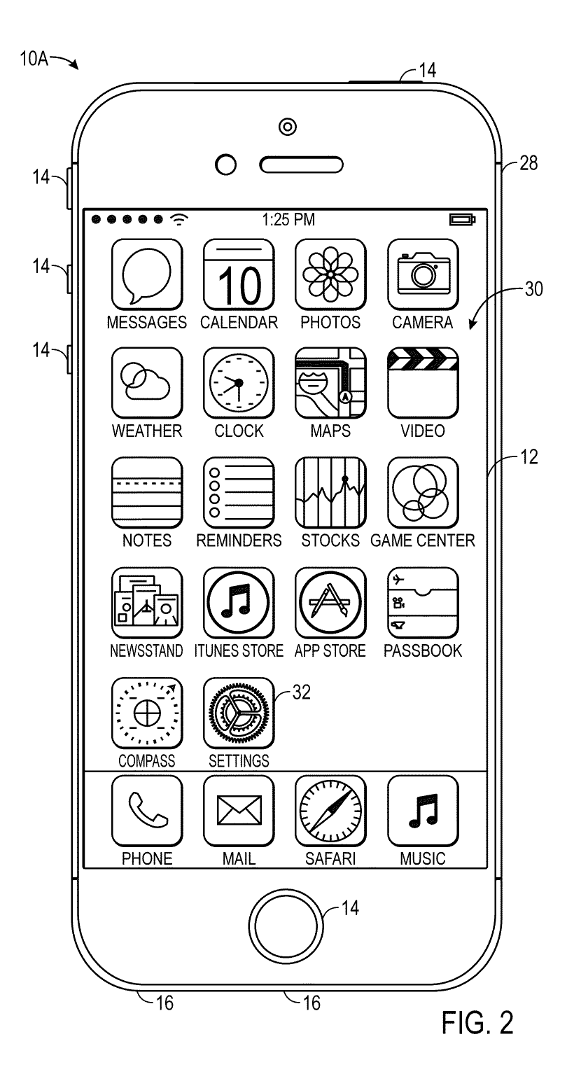

A variety of suitable electronic devices may employ the techniques described herein. FIG. 1, for example, is a block diagram depicting various components that may be present in a suitable electronic device 10. FIGS. 2, 3, and 4 illustrate example embodiments of the electronic device 10, depicting a handheld electronic device, a tablet computing device, and a notebook computer, respectively.

Turning first to FIG. 1, the electronic device 10 may include, among other things, a display 12, input structures 14, input/output (I/O) ports 16, one or more processor(s) 18, memory 20, nonvolatile storage 22, a network interface 24, and a power source 26. The various functional blocks shown in FIG. 1 may include hardware elements (including circuitry), software elements (including computer code stored on one or more tangible, non-transitory, computer-readable media) or a combination of both hardware and software elements. It should be noted that FIG. 1 is merely one example of a particular implementation and is intended to illustrate the types of components that may be present in the electronic device 10. Indeed, the various depicted components (e.g., the processor(s) 18) may be separate components (e.g., graphics processing unit, central processing unit, etc.), components of a single contained module (e.g., a system-on-a-chip device), or may be incorporated wholly or partially within any of the other elements within the electronic device 10. The components depicted in FIG. 1 may be embodied wholly or in part as machine-readable instructions (e.g., software or firmware), hardware, or any combination thereof.

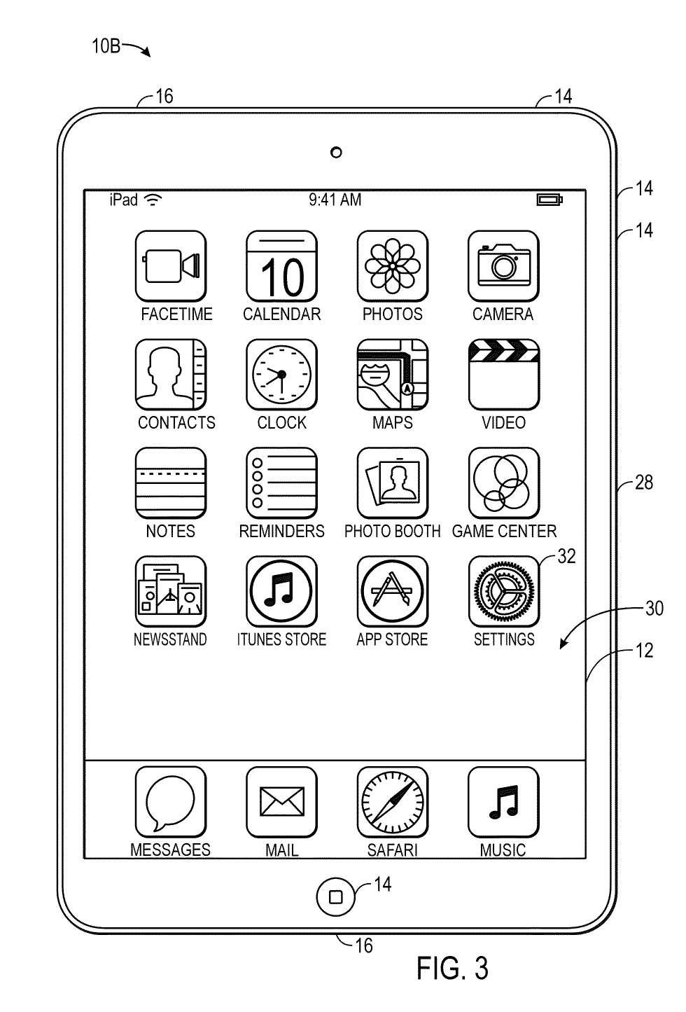

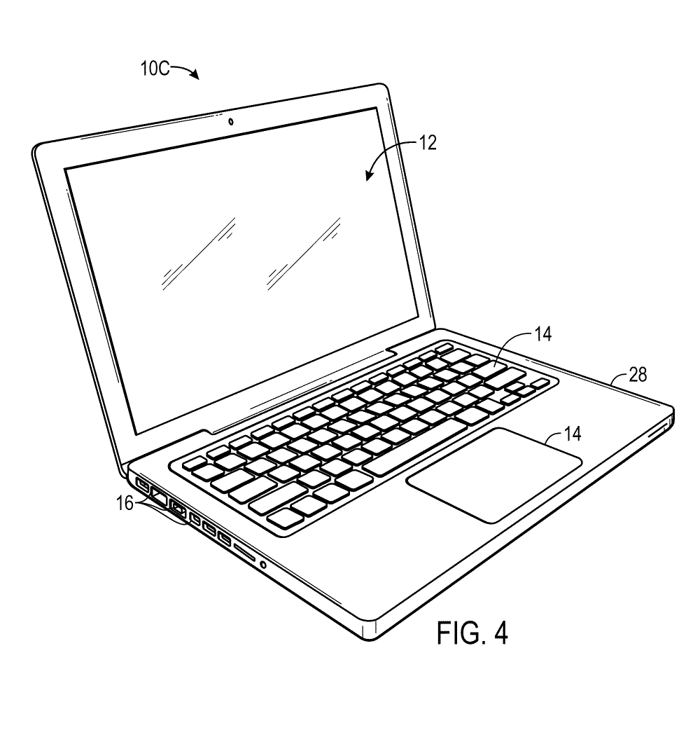

By way of example, the electronic device 10 may represent a block diagram of the handheld device depicted in FIG. 2, the tablet computing device depicted in FIG. 3, the notebook computer depicted in FIG. 4, or similar devices, such as desktop computers, televisions, servers, and so forth. In the electronic device 10 of FIG. 1, the display 12 may be any suitable electronic display used to display image data (e.g., a liquid crystal display (LCD) or an organic light emitting diode (OLED) display). In some examples, the display 12 may represent one of the input structures 14, enabling users to interact with a user interface of the electronic device 10. In some embodiments, the electronic display 12 may be a MultiTouch™ display that can detect multiple touches at once. Other input structures 14 of the electronic device 10 may include buttons, keyboards, mice, trackpads, and the like. The I/O ports 16 may enable electronic device 10 to interface with various other electronic devices.

The processor(s) 18 and/or other data processing circuitry may execute instructions and/or operate on data stored in the memory 20 and/or nonvolatile storage 22. The memory 20 and the nonvolatile storage 22 may be any suitable articles of manufacture that include tangible, non-transitory, computer-readable media to store the instructions or data, such as random-access memory, read-only memory, rewritable flash memory, hard drives, and optical discs. By way of example, a computer program product containing the instructions may include an operating system (e.g., OS X® or iOS by Apple Inc.) or an application program (e.g., iBooks® by Apple Inc.).

The network interface 24 may include, for example, one or more interfaces for a personal area network (PAN), such as a Bluetooth network, for a local area network (LAN), such as an 802.11x Wi-Fi network, and/or for a wide area network (WAN), such as a 4G or LTE cellular network. The power source 26 of the electronic device 10 may be any suitable source of energy, such as a rechargeable lithium polymer (Li-poly) battery and/or an alternating current (AC) power converter.

As mentioned above, the electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). FIG. 2 depicts a front view of a handheld device 10A, which represents one embodiment of the electronic device 10. The handheld device 10A may represent, for example, a portable phone, a media player, a personal data organizer, a handheld game platform, or any combination of such devices. By way of example, the handheld device 10A may be a model of an iPod® or iPhone® available from Apple Inc. of Cupertino, Calif.

The handheld device 10A may include an enclosure 28 to protect interior components from physical damage and to shield them from electromagnetic interference. The enclosure 28 may surround the display 12, which may display a graphical user interface (GUI) 30 having an array of icons 32. By way of example, one of the icons 32 may launch an application program (e.g., iBooks® by Apple Inc.). User input structures 14, in combination with the display 12, may allow a user to control the handheld device 10A. For example, the input structures 14 may activate or deactivate the handheld device 10A, navigate a user interface to a home screen, navigate a user interface to a user-configurable application screen, activate a voice-recognition feature, provide volume control, and toggle between vibrate and ring modes. Touchscreen features of the display 12 of the handheld device 10A may provide a simplified approach to controlling the application programs. The handheld device 10A may include I/O ports 16 that open through the enclosure 28. These I/O ports 16 may include, for example, an audio jack and/or a Lightning® port from Apple Inc. to connect to external devices. The electronic device 10 may also be a tablet device 10B, as illustrated in FIG. 3. For example, the tablet device 10B may be a model of an iPad® available from Apple Inc.

In certain embodiments, the electronic device 10 may take the form of a computer, such as a model of a MacBook®, MacBook® Pro, MacBook Air®, iMac®, Mac® mini, or Mac Pro® available from Apple Inc. By way of example, the electronic device 10, taking the form of a notebook computer 10C, is illustrated in FIG. 4 in accordance with one embodiment of the present disclosure. The depicted computer 10C may include a display 12, input structures 14, I/O ports 16, and a housing 28. In one embodiment, the input structures 14 (e.g., a keyboard and/or touchpad) may be used to interact with the computer 10C, such as to start, control, or operate a GUI or applications (e.g., iBooks® by Apple Inc.) running on the computer 10C. Furthermore, in some embodiments, the electronic device 10 may include server and/or cloud computing devices.

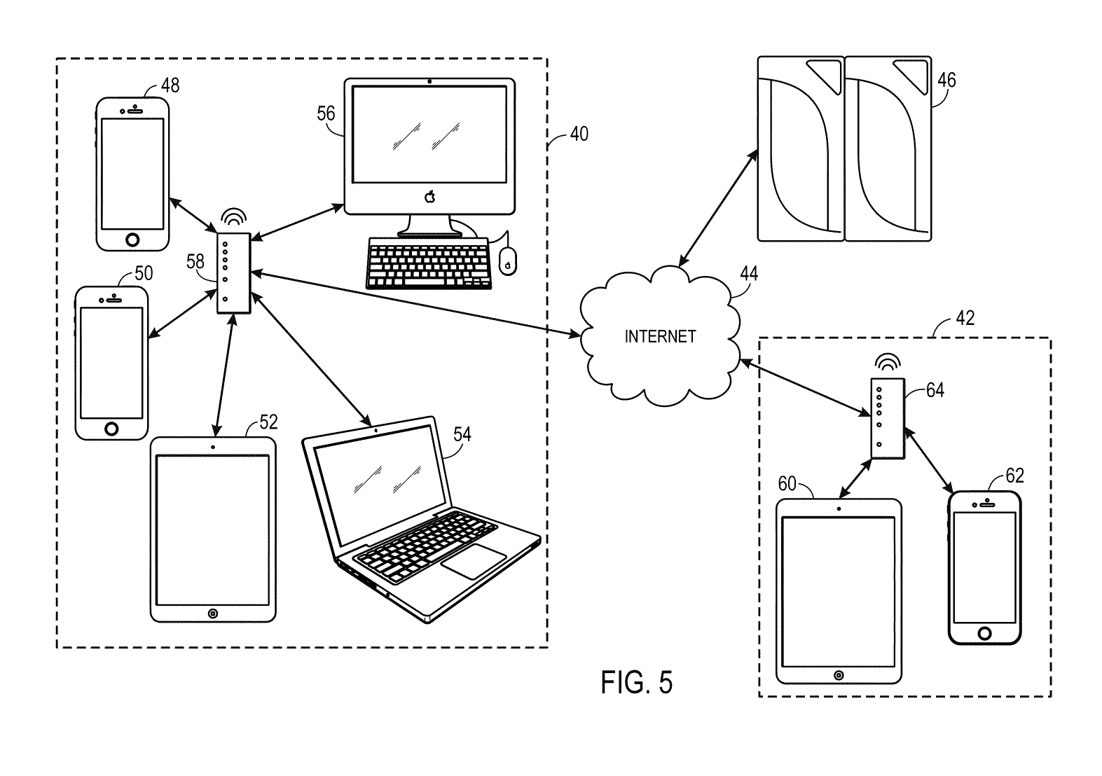

With the preceding in mind, FIG. 5 illustrates block diagram view of an interconnection of various electronic devices 10. As illustrated, local networks, such as networks 40 and 42, may interconnect via the Internet 44 and/or other wide area networks. Additionally, the networks may connect to one or more servers 46 through the local networks and/or wide area networks. The servers 46 may include one or more locally-connected or distributed computing devices, storage devices, and/or data warehouse appliances. Each of the networks includes one or more electronic devices 10. For example, the network 40 includes handheld devices 48 and 50, a tablet device 52, a notebook computer 54, and a desktop computer 56 each connected to the Internet 44 and each other via a router 58, and the network 42 includes a tablet device 60 and a handheld device 62 connected to each other and the Internet 44 via a router 64. Each of the devices in the network may be connected to the router 58 or 64 using a wired (e.g., Ethernet) or wireless (e.g., WiFi) connection. Moreover, in some embodiments, a single network may include more than one router. In certain embodiments, one or more electronic devices may be connected directly to the Internet 44 without a router but directly connected via a modem. Additionally, in some embodiments, one or more of the electronic devices 10 may directly connect to each other within a respective network. For example, the tablet device 52 may connect to the notebook computer 54 using a wired (e.g., USB) or wireless (e.g., Bluetooth or WiFi) connection.

### Application Program Development

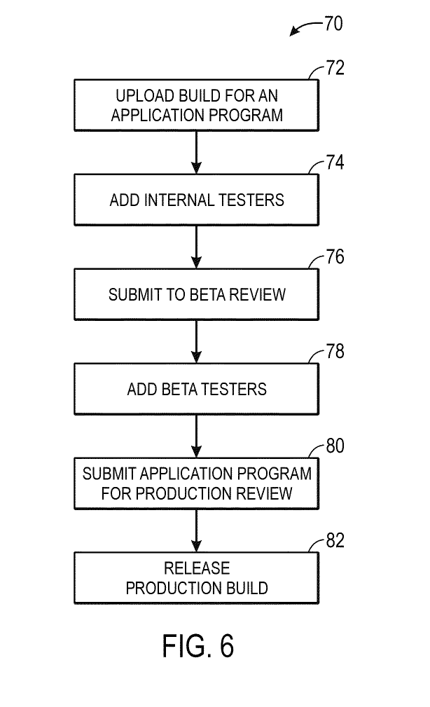

Each of the electronic devices 10 may store and execute application programs in a respective storage 22. In some embodiments, these application programs may be developed using one or more electronic devices (e.g., notebook computer 54) and uploaded to the servers 46 to be retrieved, stored, and installed on other electronic devices (e.g., tablet device 60). FIG. 6 illustrates a process 70 for sharing and testing application programs. A development electronic device, such as the notebook computer 54, uploads a build of the application program to the servers 46 of a distribution organization (block 72). In some embodiments, the servers 46 may derive metadata information from the uploaded build. For example, when the developer uploads the build, the servers 46 may automatically determine a name, an icon, supported languages, version information, and/or other information in the build that may be desired by the distributing organization.

The developer may add internal testers (block 74) that may immediately view, download, upload, or modify the application program settings, fees, and/or code. In some embodiments, one or more of the internal testers or the developer, via an electronic device, may submit the application program build for beta review (block 76) so that beta testers may be added for the application program (block 78). In some embodiments, invitations to the beta testers may be delayed until a beta testing review has occurred. In other embodiments, the beta testers are invited as soon as the beta testers are added. Once beta testing has been completed, a production version of the build may be submitted for a production review (block 80). Once the production build has been approved, the build may be added to an online store that enables any user access to the application. (block 82) In some embodiments, a distributing organization may conduct a single review to replace the both the beta review and the production review. In some embodiments, this single review may be conducted prior to, during, or after beta testing.

In other words, a developer of an application program may designate two different classifications of testers: internal testers and external (e.g., beta) testers. In some embodiments, the internal testers may be a group of developers that may exert a level of control over the application program. For example, in some embodiments, internal testers may change prices of the applications, edit and reupload builds, invite beta testers, determine which builds are to be beta tested, and/or other application program controls. In certain embodiments, internal testers may include other developers that are already registered as a developer with a distributing organization (e.g., organization operating the servers and reviewing the application program). For example, the internal testers may be iTunes® Connect users that are part of the iOS® Development Program or the Mac® Developer Program.

On the other hand, beta testers may be any person that the developer wants to add to his beta testing group. Furthermore, internal testers may have access to more than one build and/or may have access to builds immediately after the builds are uploaded. Beta testers may instead only receive builds that have been selected for beta testing by the developer, one or more internal testers, and/or the distribution organization via beta review.

### Developer Controls

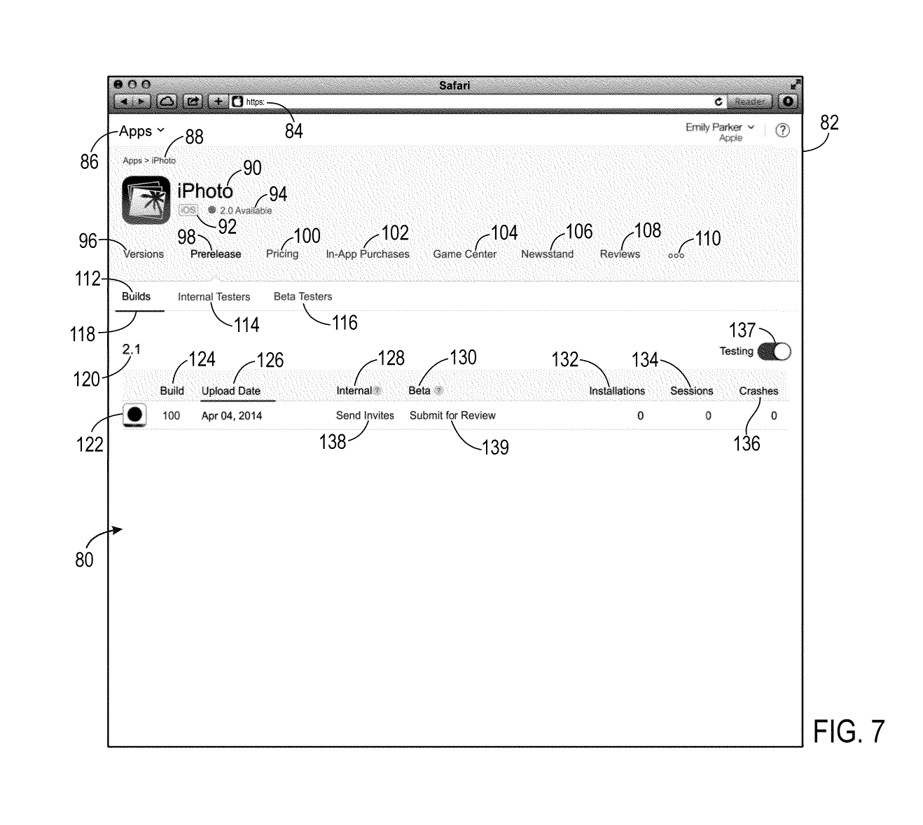

FIGS. 7-16 illustrate an embodiment of an interface that may be used by an electronic device 10 of a developer employing the process 70 to add internal and external (beta) testers. FIG. 7 illustrates a screen 80 that the electronic device 10 might present to a developer. In some embodiments, the screen 80 may be presented using a web browser application 82, such as Safari® available from Apple Inc. In other embodiments, the screen 80 may be presented using a dedicated application program.

When the screen 80 is presented using a web browser, the developer may navigate to an application program management page via a uniform resource locator (URL) 84. The URL 84 may direct the browser to display a menu of information and options, such as menus for inspecting or uploading application programs, managing payment information, or inspecting or uploading media (e.g., movies, music, or application programs) for sale. Upon selection of the application programs menu, the screen 80 may be displayed by the browser 82 as indicated by a title 86. The screen 80 further shows that iPhoto® has been selected as indicated by an application title 88. The screen 80 also shows additional information that may be presented to the developer. For example, the screen 80 may show an application name 90, an operating system or environment 92 for the application program, a currently available version 94 of the application, and/or additional information that may be helpful for the developer to be able to quickly identify about the application program and/or its versions and builds.

The screen 80 also includes eight tabs 96, 98, 100, 102, 104, 106, 108, and 110 that provide different options and actions to the developer in managing the applications. The name of the selected tab may be shown differently than other tabs to indicate which tab is currently selected. In some embodiments, the screen 80 may include more or less tabs. For example, the screen 80 may include 0, 1, 2, 3, 4, 5, or more tabs. Within the prerelease tab 98 of screen 80, three sub-tabs—a builds tab 112, an internal testers tab 114, and a beta testers tab 116. An indicator 118 may be used to indicate which tab has been selected. For example, the indicator 118 indicates that the builds tab 112 is currently selected.

Within the builds tab 112, one or more versions 120 may be presented with respective builds. For example, in the current embodiment, a single version—2.1—has a single build 100. Data pertaining to the builds may be presented in columns or any other suitable presentation format. The presented data may include an application icon 122 for the build, a build number 124, an upload date 126 for the build, information about internal testers 128, information about external or beta testers 130, a number of installations 132 of the build, a number of sessions 134 of the build, a number of crashes 136 of the build, and/or other pertinent information about the build. In some embodiments, a testing button 137 may be included to toggle whether the application program is to be tested. In some embodiments, the internal testers information 128 and/or the beta testers information 130 may include statuses of the internal and beta testing process including corresponding link 138 and 139 to complete the next steps. For example, the illustrated link 138 provides a link 138 that when selected causes invitations to be sent to the internal testers, if internal testers have been previously added. Similarly, the illustrated link 139 when selected causes the build to be submitted for review or provides a page for inputting information that may be used in the review process.

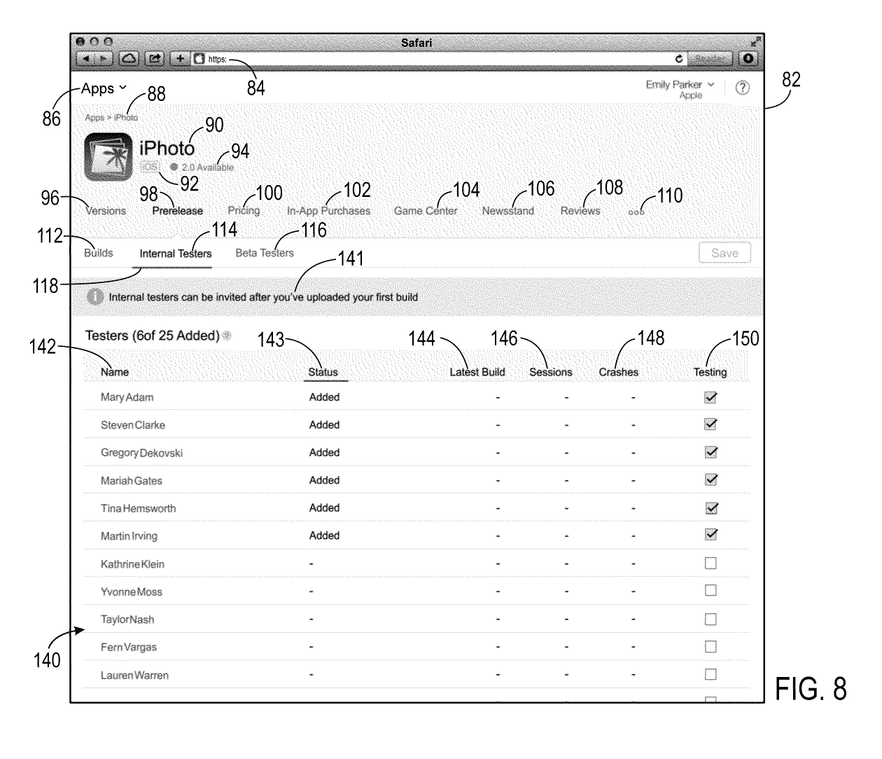

In some embodiments, internal testers may be added to the application program before even a single build is uploaded for the application program. For example, screen 140 of FIG. 8 illustrates a selection of the internal testers tab 114 as indicated by the indicator 118. Within the internal testers tab 114, an announcement section 141 may be included to share relevant information. For instance, as previously noted, in FIG. 8 the internal testers are added prior to upload of a build for the currently tested version, and the announcement section 141 informs the developer of this situation. Accordingly, in the present embodiment, the announcement section 141 indicates that the internal testers will not be invited until after the first build has been uploaded. In some embodiments, the announcement section 141 may also inform the developer about a server status of the servers 46. The announcement section 141 may also inform the developer how many internal testers are added and how many additional internal testers may be added.

In some embodiments, a brief summary may be included for each added tester. For example, a name 142 for each tester indicates a name of the internal tester. Status information 143 may be displayed about each particular tester. Specifically, the status information 143 may indicate whether the tester has been added, has been invited, has accepted the invitation, has quit internal testing, or is currently an active tester for the application program build. A latest build 144 may be used to indicate the most recent build that the tester has been using. Likewise, sessions 146 and crashes 148 may indicate how many times the tester has run the build or application and experienced a crash, respectively. A testing toggle 150 may be used to indicate whether the internal tester should be added as a tester for this build. In other words, internal testers may be added to the tab but selected for or removed from testing at a different time. This later flexibility of testing status may be useful for prioritizing internal testers, which may be particularly helpful if a number of allowed internal testers is limited. For example, in the current embodiment, six internal testers have been assigned out of the maximum of 25 internal testers. Thus, the developer may be able to quickly ascertain whether additional internal testers should be added or if the spots should by saved for other more desirable (e.g., different technical levels or demographics) testers. In other embodiments, different limits (e.g., 5, 10, 15, 20, or more internal testers) may be placed on the total number of internal testers.

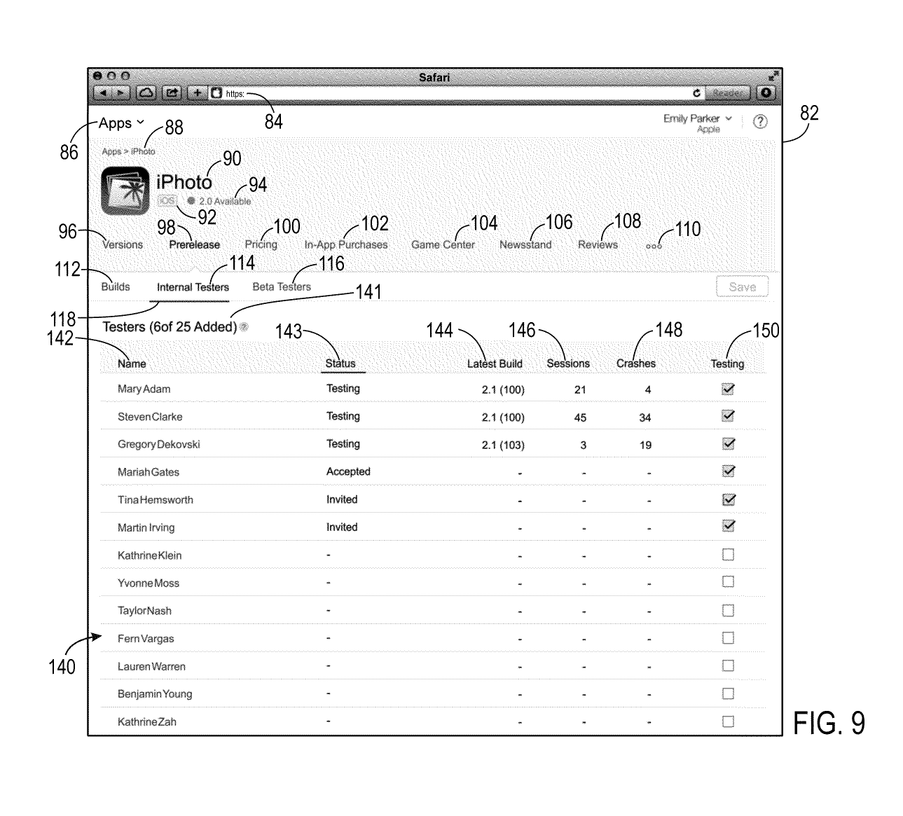

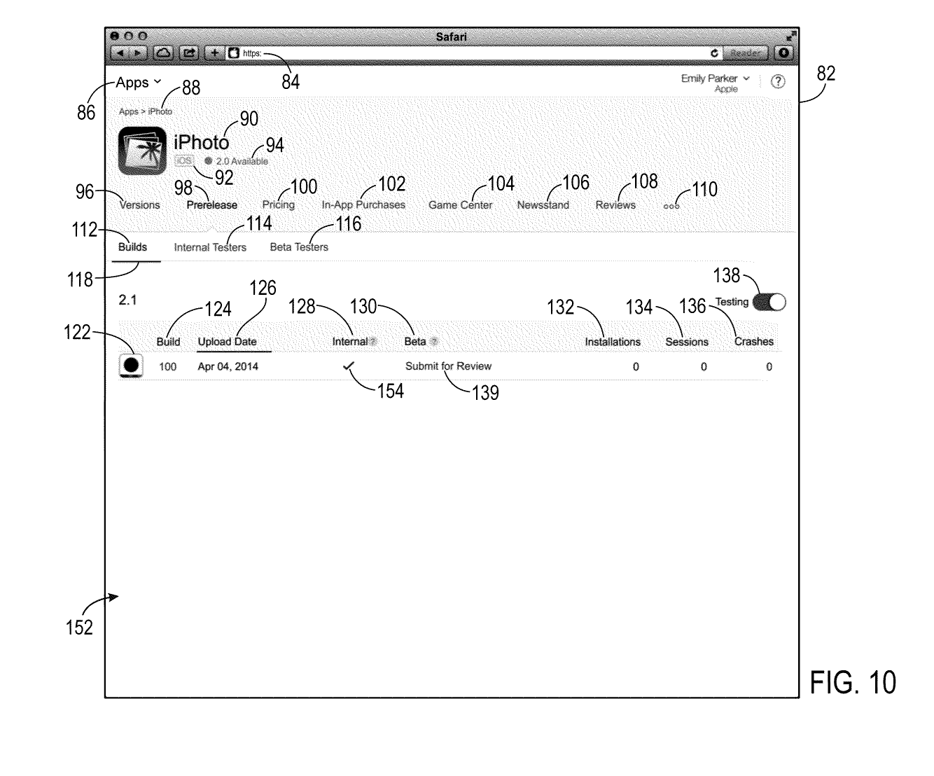

FIG. 9 illustrates the screen 140 after a build has been uploaded an internal testers have been added. As indicated, three designated internal testers are actively testing the application. Another internal tester has accepted the invitation but has not begun testing. Two other testers have been invited but have not accepted the invitation currently. FIG. 10 illustrates a screen 154 that illustrates that an application program build 100 has been uploaded and internal testers have been invited as indicated by the check 154 in the internal testers information 128. In other embodiments, any suitable indication may be used to inform the developer that internal testers have been invited using the link 138 of FIG. 7. In some embodiments, once the developer indicates that the developer desires to send invites, the screen may provide a confirmation window that requests confirmation that the developer intends to invite the number of indicated internal testers.

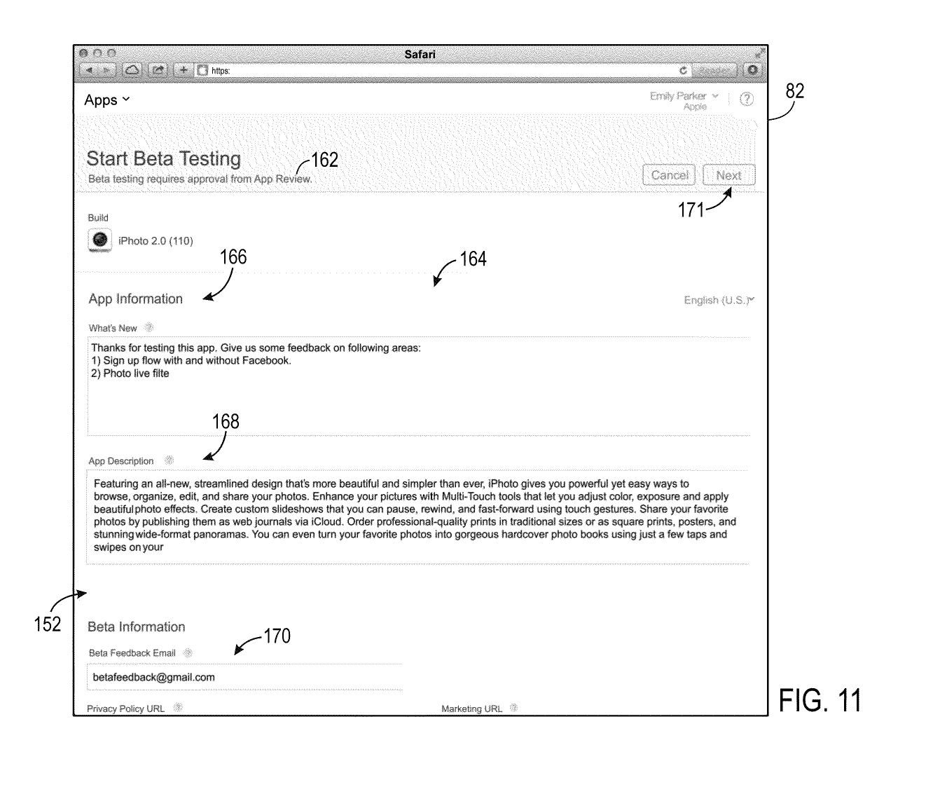

When a developer selects to submit a build for beta testing via the link 139 or the beta testers tab 116, a starting beta testing screen may be displayed, such as the screen 160 of FIG. 11. In the illustrated embodiment, the screen 160 includes an announcement section 162 that instructs the developer that beta testing will not begin until the application has been reviewed and approved by the distributing organization. In other embodiments, the announcement section 162 may inform the developer that the application program has been approved, a status of the servers 46, a permanent or temporary hiatus enforced for the application, and/or an expected duration until application review has been completed.

The screen 160 also includes an app information section 164 that enables the developer to provide information for beta testers to see when the beta testers add the application program to their electronic devices. For example, the information section 164 may include a new information section 166, an app description section 168, and a beta information section 170. The new information section 166 may provide a place for the developer to provide a description of newly added features to be tested in the beta tests. The app description section 168 enables the developer to provide a brief description detailing the functions of the application program. The beta information section 170 allows the developer to provide contact information (e.g., contact name, contact email address, contact phone number, contact address, etc.) for receiving beta testing results or other beta testing information. In some embodiments, the screen 160 may further include additional information that may be relevant to the distributing organization. For example, the screen 160 may include a questionnaire that asks pertinent questions about the build about which the distributing organization may desire to know, such as “Have you made any significant changes to this beta build since your previous submission?” The responses to the questionnaire may be used to assist the distributing organization in reviewing the newly-submitted build. In certain embodiments, the screen 160 may include a process advancement navigation 171 that allows the user to advance to the next step in the beta testing process or to cancel the current step of the beta testing process.

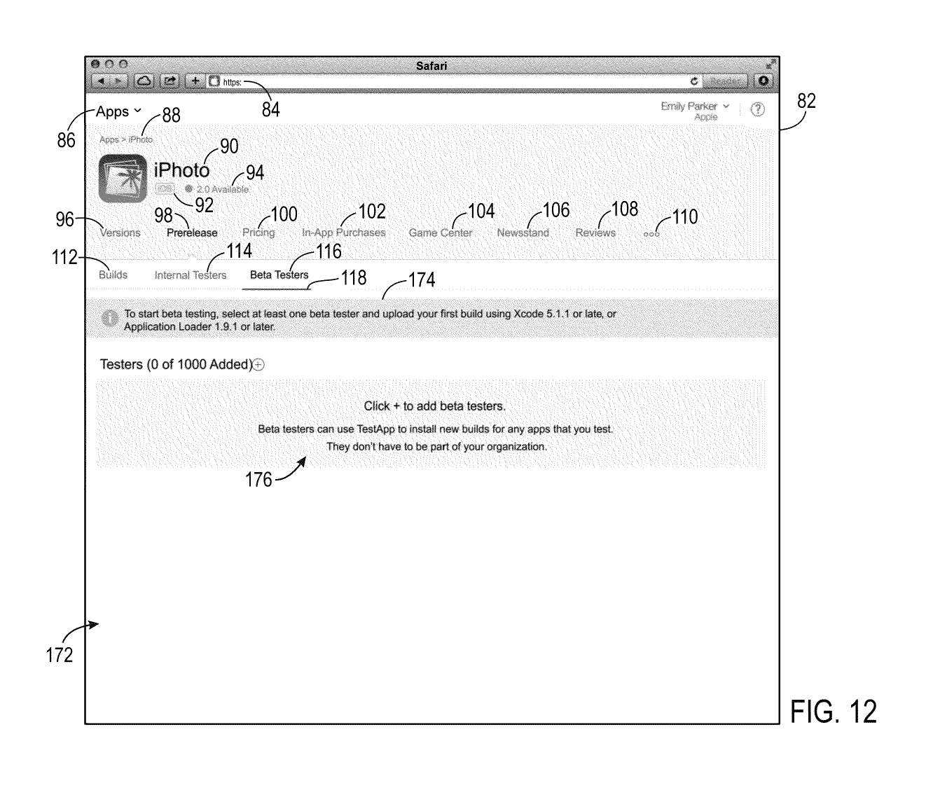

FIG. 12 illustrates an embodiment of a screen 172 that may be accessed using the process advancement navigation 171 of FIG. 11. The screen 172 used to add beta testers to the beta testing program under the beta testing tab 116. The screen 172 may include an announcement section 174 that informs the developer of various details. For example, if a developer is attempting to add beta testers, the announcement section 174 may inform the developer that that a first build should be uploaded before best testing is started. The announcement section 174 may also inform the developer that beta review may need to be completed before beta testing can be begun. For example, the announcement section 174 may state “Beta testers may be invited once the beta build has been approved.” The announcement section 174 may also inform the developer that the beta build has already been approved, server status, estimated time until the build has been reviewed, a number of added beta testers, a limit on the number of beta testers, and/or other suitable information. For example, the illustrated embodiment informs the developer that 0 of 1,000 testers have been added. In certain embodiments, the number of internal testers and beta testers may be different from each other.

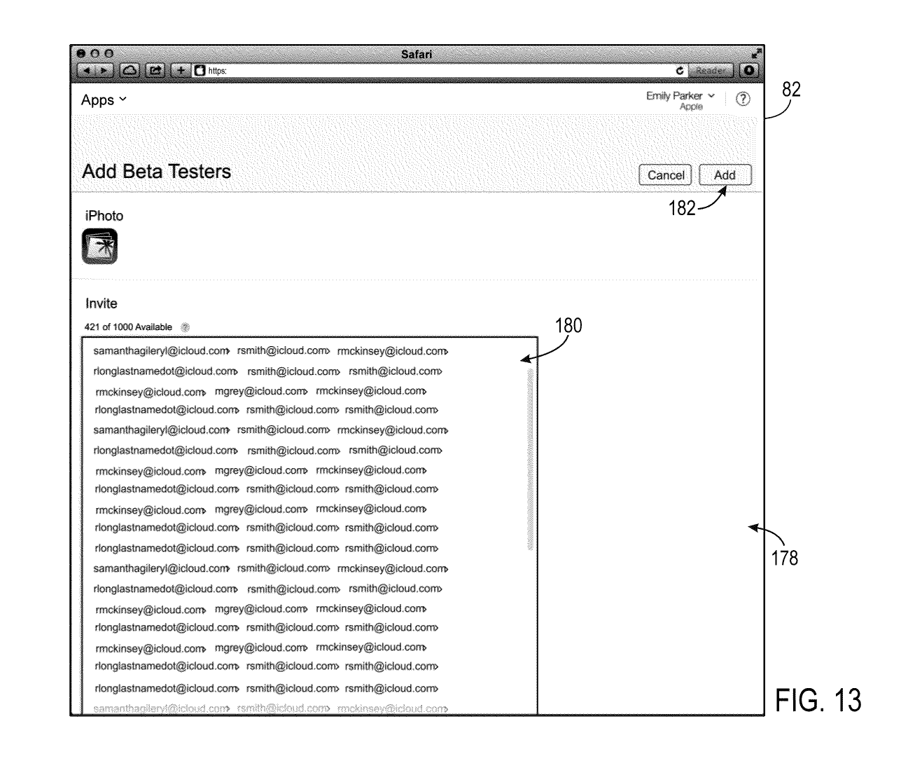

To add beta testers, the developer may select a beta tester addition box 176 that opens a beta testers input screen 178 illustrated in FIG. 13. As illustrated, the beta testers input screen 178 includes an input box 180 into which the developer may enter contact information for desired testers. In some embodiments, the developer may invite users that are registered with the distributing organization, but the contact information does not correspond with contact information known by the distributing organization. Instead, the contact information may be used to contact the desired beta testers with information detailing how the intended tester may join a beta test. For example, the developer may use a contact email address for desired testers that is different than an email address used by the tester for an iTunes account.

As will be discussed below, the desired tester is contacted via the contact information and may become a beta tester without giving confidential iTunes account information to developers. Thus, the tester may keep iTunes contact information private while participating in the beta test. In some embodiments, contact information may include a phone number (e.g., with a texted link), a physical address (e.g., a postcard with URL attached), and/or other contact information may be used. To complete the beta testers addition process, the screen 178 may include a beta tester addition navigation 182 that may be used to confirm or cancel the addition of the testers input into the input box 180.

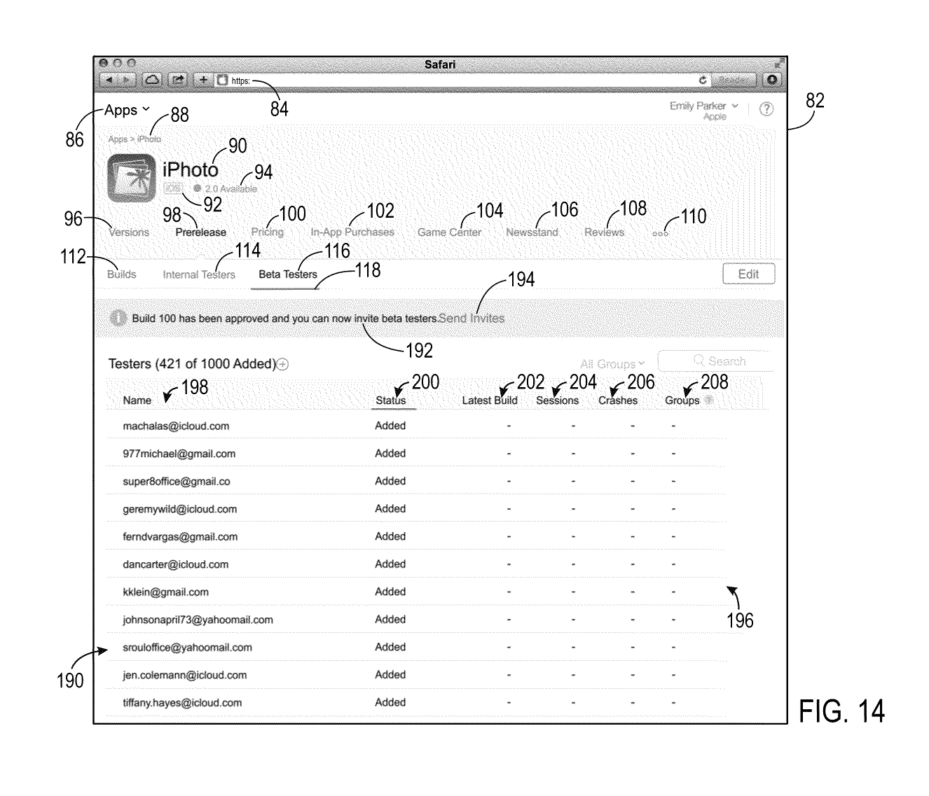

After beta testers are added, a beta testers added screen, such as the beta testers added screen 190 of FIG. 14, may be displayed on a developer's electronic device. In some embodiments, the beta testers added screen 190 may include an announcement section 192 informing the developer of pertinent information. For example, the announcement section 192 may include statements such as “Build has been approved, and you can add beta testers” or “Beta testers may be added, but beta testers will not be invited until your build has been approved.” In some embodiments, the announcement sections 192 may further include a send invites button 194 that allows the developer to begin the invitation process when the developer is ready to add the beta testers. In some embodiments, a listing of beta testers 196 may be viewed and/or sorted using corresponding contact information 198. In certain embodiments, the listing 196 may also include a status 200 of each tester, a latest build 202 used by each tester, a number of sessions 204 initiated by each tester, a number of crashes 206 encountered by each tester, groups 208 for each tester, and/or other information that might be relevant to the developer. In some embodiments, the listing may be sorted by contact information 198, statuses 200, builds 202, number of sessions 204, number of crashes 206, and/or group name 208.

In some embodiments, the developer may group the beta testers into various groups, such as designers, internal developers, quality assurance, stakeholders, friends, family, another suitable grouping of users, or some combination thereof. The grouping of users allows the developer to quickly review that an intended type of review is being conducted by sorted the listing 196 by group types (e.g., quality assurance).

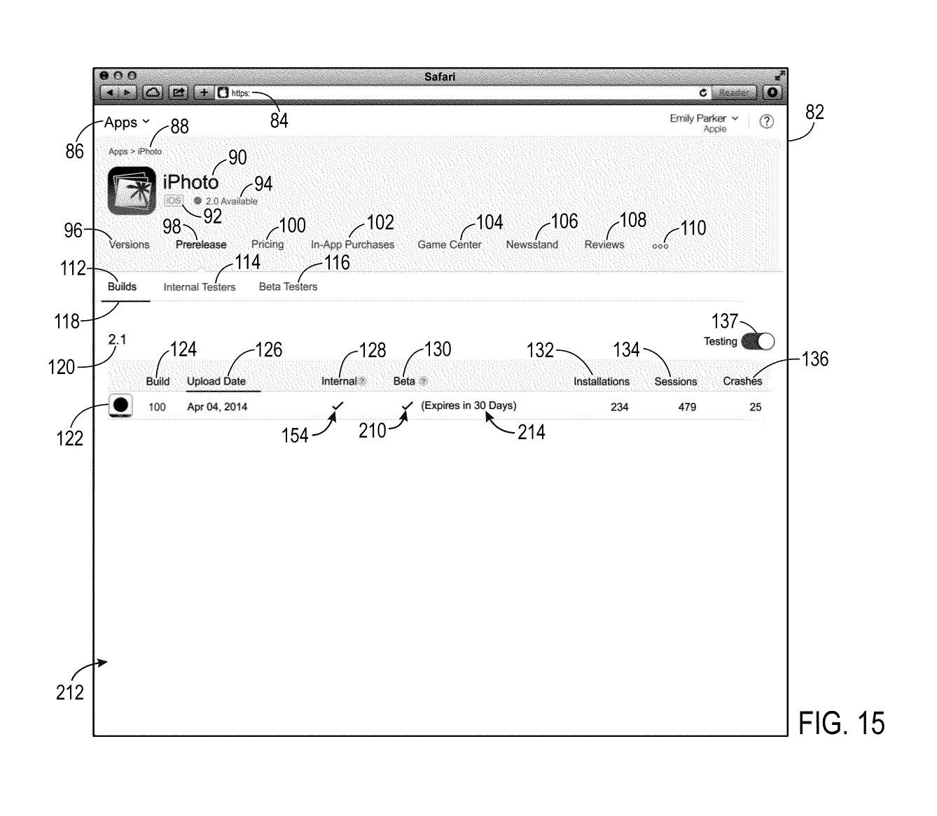

Returning to the builds tab 112 after the beta testers have been added, a quick summary screen 212 as illustrated in FIG. 15 may be presented to the developer via an electronic device. The quick summary screen 212 informs the developer that at least one beta tester and one internal tester have been invited via checkmarks 154 and 210. Additionally, in some embodiments, beta testing may be limited in duration (e.g., 10, 15, 30, 45, 90, or more days), and the quick summary screen 212 may inform the developer how much time is remaining in the beta testing duration using a time left indicator 214.

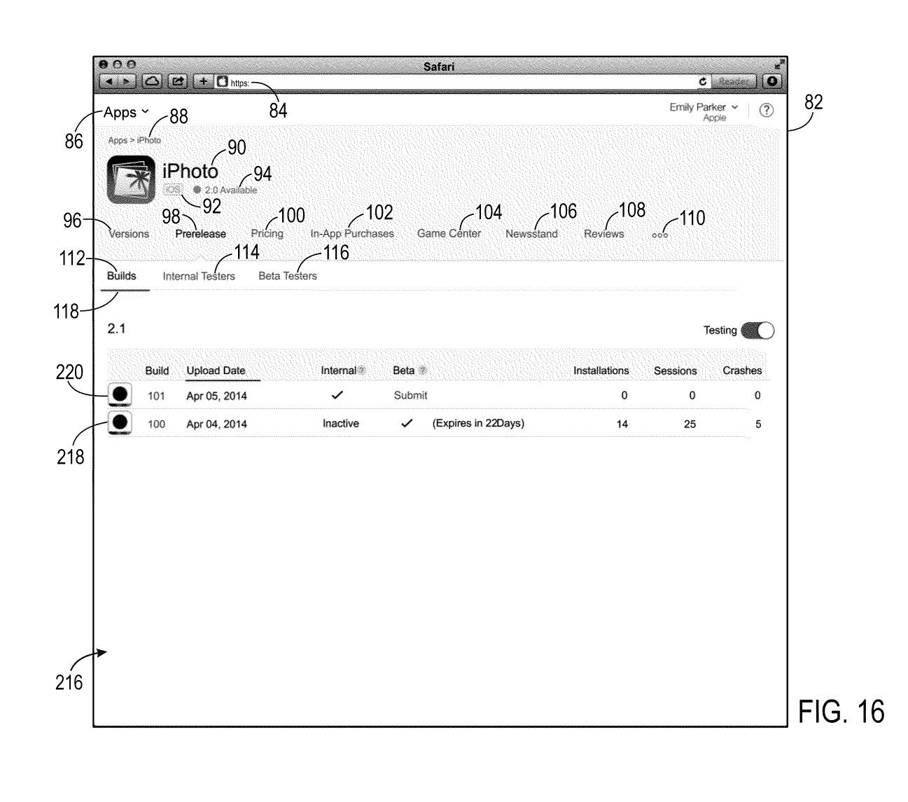

Although the foregoing discusses only a single build of an application program, a developer may add additional builds or version trains at a later time even when a current build is already being beta tested. For example, a build tab screen 216 of FIG. 16 illustrates two builds 218 and 220. As illustrated, the earlier build 218 was being tested at the time that the later build 220 was added.

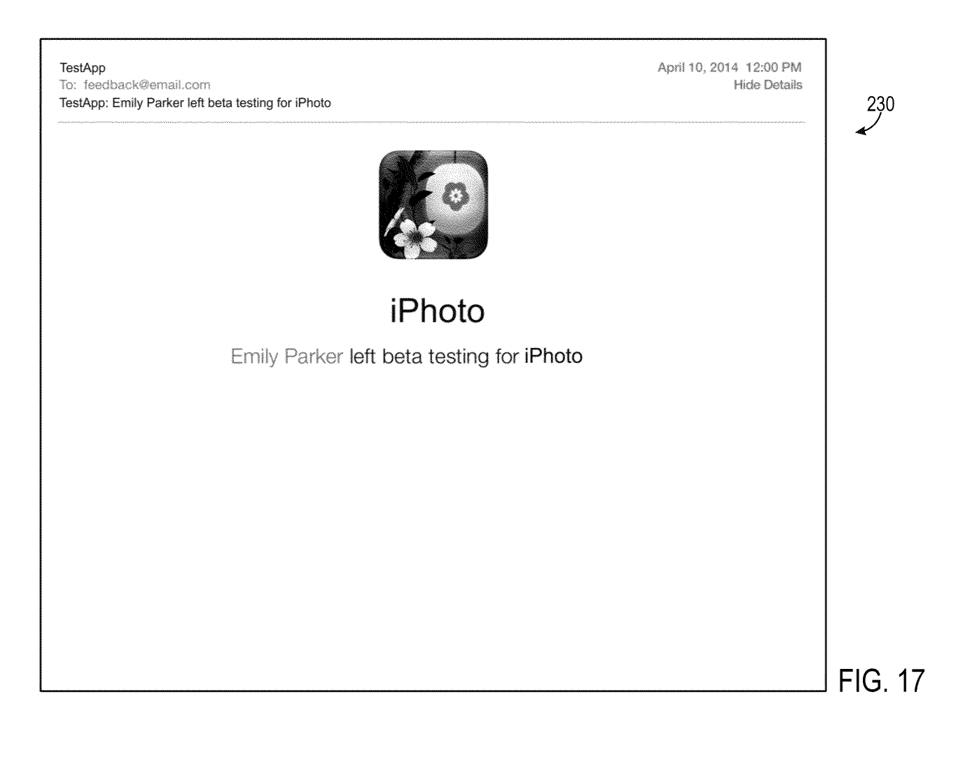

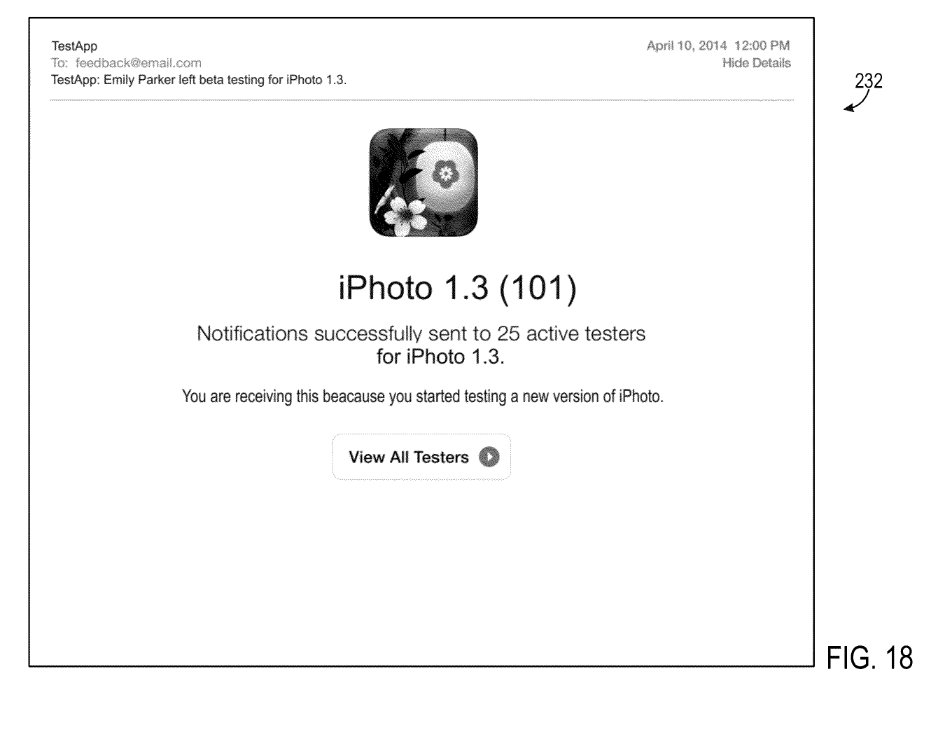

Although the developer may review data related to a build through a website or testing application program, in some embodiments, some details may be sent to the developer as notifications. For example, the developer may receive a notification via email, via text message, via a notification screen of a device, notification within a testing application, or other suitable method for informing the developer of changes in the beta testing process and/or testers. For example, FIG. 17 illustrates an email 230 that a developer may receive when a beta tester chooses to leave the beta testing program. Similarly, FIG. 18 illustrates an email 232 that a developer may receive when invites are sent for the beta testing program.

### Beta Testing Application Program

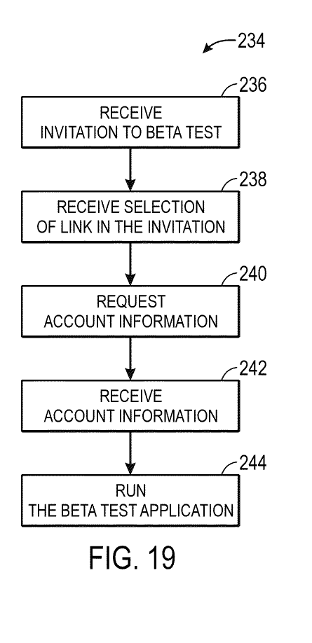

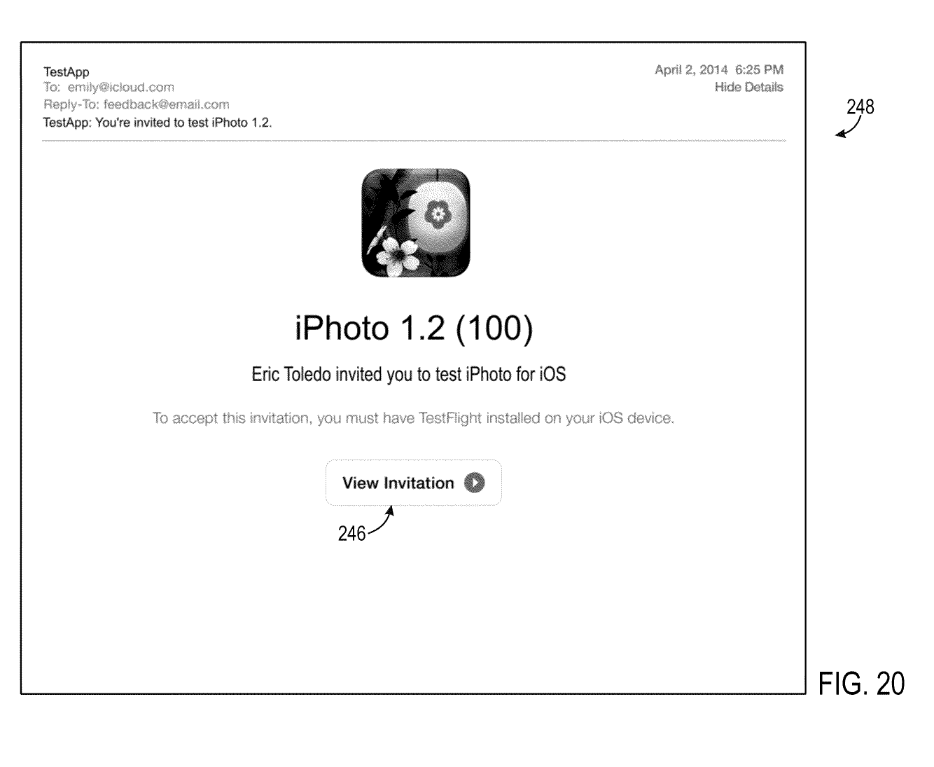

FIG. 19 illustrates a process 234 that may be executed by an electronic device of a potential tester. As previously discussed, a tester's first exposure to the testing process may be through an invitation to join a beta test (block 236). In some embodiments, the invitation may be received by email, text message, and/or other device to device communication links between electronic devices of the tester and developer, such as AirDrop®, near field communication, local WiFi connections to the same network, Bluetooth, infrared, or other suitable communication links. Furthermore, the invitation may be received at the electronic device upon which the tester will be running the tests. In other embodiments, different electronic devices may receive and conduct the beta testing. The invitation may include a link, such as link 246 in invitation 248 of FIG. 20.

When the electronic device receives a selection of a link in the invitation, the electronic device opens the link (block 238). In some embodiments, the link may include a hyperlink that is opened in a browser of the electronic device. In certain embodiments, the link may be application specific, and the electronic device may open the link through specific application, such as a beta testing application or an application program used to distribute application programs, such as a store operated by the distributing organization. In any case, the electronic device requests account information from the tester (block 240). The electronic device then receives the account information (block 242). The account information may be an account that the tester has previously established with the distributing company, or, instead, the tester may establish a new account. In any case, the tester may authenticate the account without providing contact information or login information to the developer for the account, since, as discussed below, the servers 46 are able to link the tester with an account without requiring the developer to know contact information about the user.

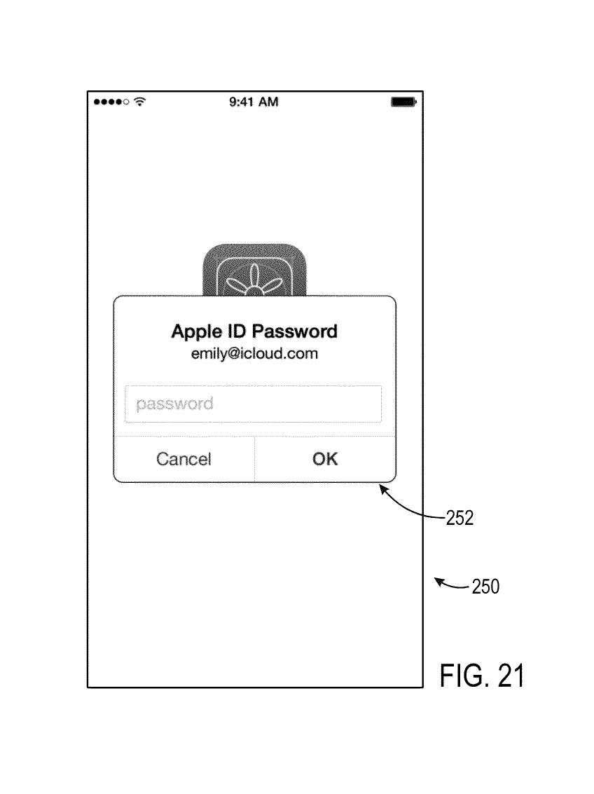

Once the electronic device has authenticated an account via a connection with the servers 46, the electronic device may run the beta tested application (block 244). For example, the electronic device may download a testing application be used to download, manage, or view beta tested applications. In some embodiments, the testing application program may already be downloaded and authentication of account may link the invitation to a tester's account without the tester sharing account information with the developer. For example, the electronic device may request the account information using the beta testing application 250 as illustrated in FIG. 21. For example, in the illustrated embodiment a username of emily@icloud.com may be stored in the electronic device, and a dialogue box 252 requests the password for the Apple ID of emily@icloud.com. In other embodiments, the dialogue box 252 may request a username and a password. In some embodiments, the testing application 250 may acquire authentication from the user using fingerprint identification, near field communication identification, other biometric identification, and/or other authentication methods that may be available to the electronic device. In some embodiments, the authentication information may be linked to one or more beta test invitations, and the tester may search for beta tests to which the tester is participating by using the authentication information.

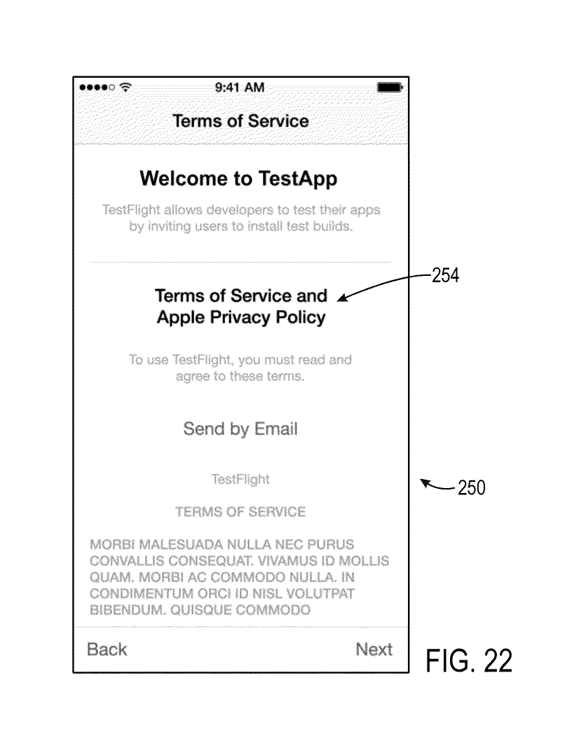

In some embodiments, the beta testing application may display additional information before running or testing the tested application. For example, the testing application may display a terms of service and privacy policy 254 of FIG. 22 that is presented to the tester when the tester opens the testing application for the first time, each time the testing application is opened, each time the tester adds a new tested application, and/or other suitable periods.

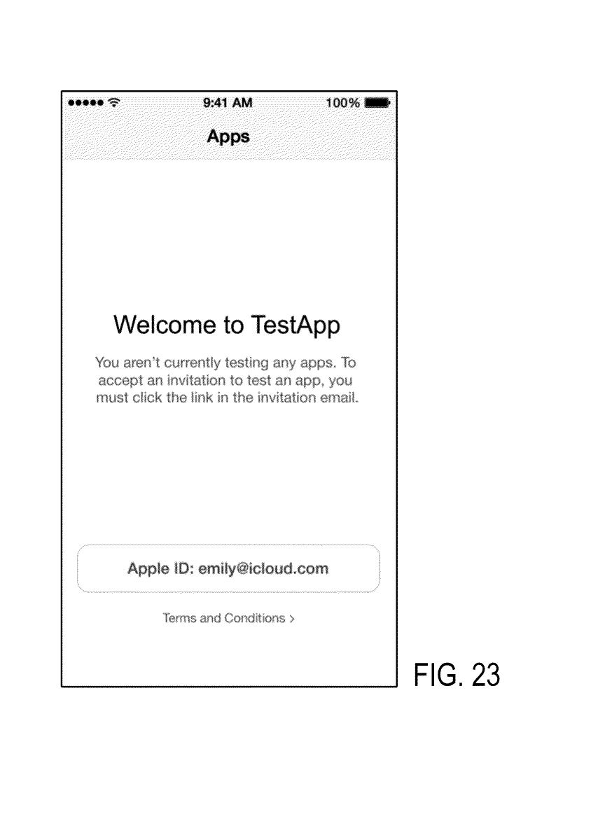

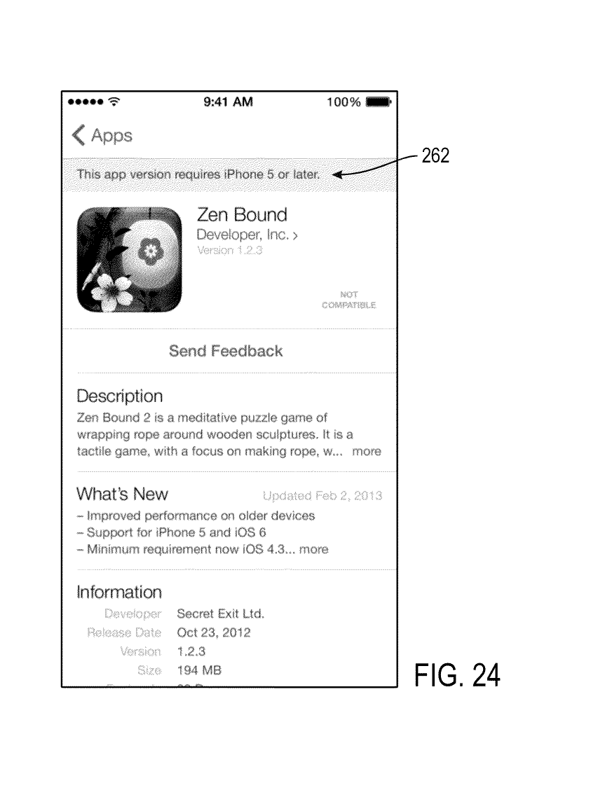

In some embodiments, a user may add the testing application to one or more electronic devices without first receiving an invitation to beta test an application program. In such embodiments, when the testing application is opened, the testing application may inform the user that they are not currently testing any apps. For example, the notification screen 260 of FIG. 23 informs a user that the user is not currently beta testing any application programs. In some embodiments, a beta tested build may be restricted to an operating system, a specific electronic device, and/or other specific test scenarios that the developer desires. Accordingly, in some scenarios, the tester may not have the desired hardware or operating system for the build being beta tested. In such scenarios, the testing application may inform the user that the application program build to be tested requires a different electronic device or operating system. For example, a device notification 262 of FIG. 24 informs the user that the beta test for this build applies to iPhone 5 or later devices.

In some embodiments, the testing application may visually emulate another application that the tester may be comfortable with. For instance, the testing application may emulate an application program store that is operated by the distributing organization. For example, the testing application may emulate the App Store^{SM} as illustrated in FIG. 24. It should be noted that the electronic device may run the testing application and the App Store^{SM} as separate application programs. Indeed, the App Store^{SM} may be used to install the testing application. Furthermore, in addition to emulating the App Store^{SM} in appearance, in some embodiments, the testing application may connect to servers that emulate an App Store^{SM} environment that are separate from the App Store^{SM} servers and operate with different rules. For instance, when beta testing an application program, the testing application may connect to beta testing servers that enables a sandbox environment that allows the tester to install an application that normally costs money for no cost. Furthermore, in some embodiments, the beta tested application may continue to connect to the sandbox environment and allow the tester to “purchase” in-app purchases without paying any fees.

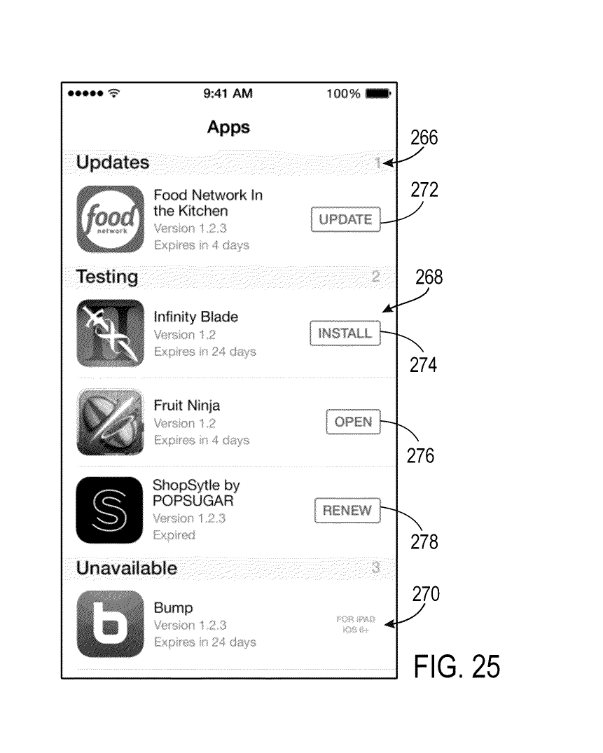

In certain embodiments, as illustrated in FIG. 25, after one or more tested applications have been linked to the tester's account, the testing application may present applications that are available to update 266, ready to test 268, or are unavailable to test 270. Each application available for testing may have an action button that enables the tester to perform a respective action for the respective application program. For example, the testing application may include an update button 272 with which the tester may update applications. The testing application may also include an install button 274 that enables the tester to install applications to which the tester has been invited. Additionally, the testing application may include an open button 276 that enables the tester to open applications from the testing application. Furthermore, the testing application may include a renew button 278 that enables the tester to renew a testing period after the developer and/or the distributing organization has begun a new beta testing duration or has extended or restarted the current testing period.

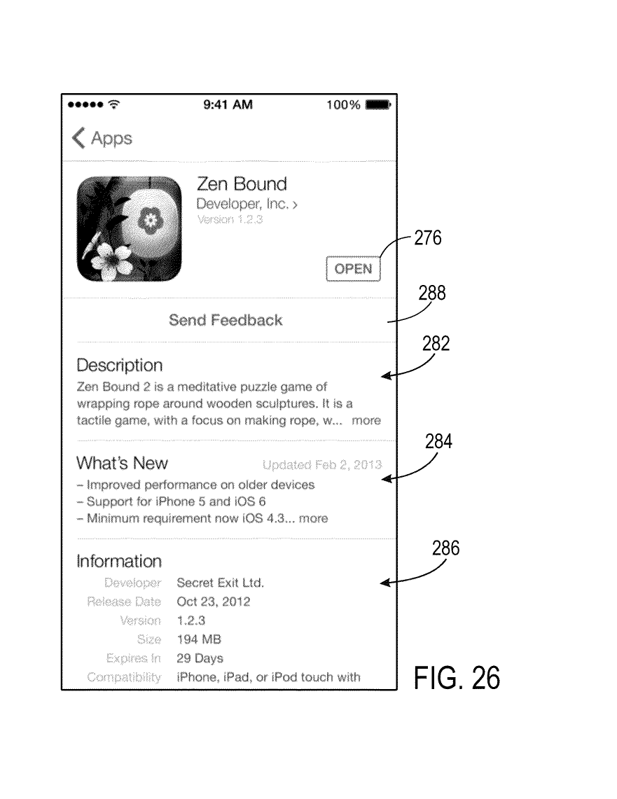

Within the testing application, the electronic device 10 may present additional information about the build being beta tested. For instance, as illustrated in FIG. 26, using the testing application, the electronic device may display a description 282, new features 284, and general information 286 of the application, each of which was previously entered by the developer. Additionally, in some embodiments, the testing application may provide a feedback button 288 that the tester may use to provide feedback to the developer. In some embodiments, the feedback button 288 may open a form that the distributing organization sends to the developer (e.g., e-mail address input as the beta testing address contact). In certain embodiments, the feedback button 288 may open a chat session, initiate an email message, initiate a text message, and/or other method for contacting the developer. In some embodiments, the tester may provide feedback to the developer through a feedback button provided within the tested application. For example, in some embodiments, when the operating system of the electronic device identifies the application as a beta test, the operating system may cause the electronic device to display a button within the tested application with which the tester may provide feedback to the developer.

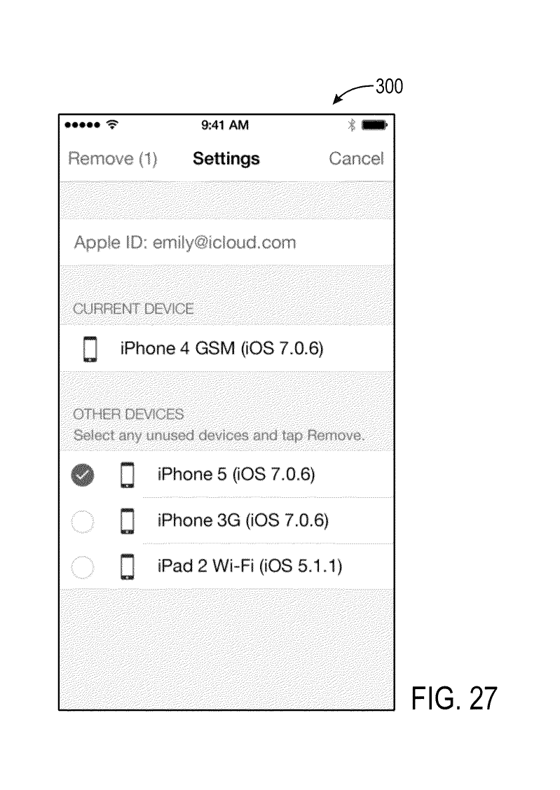

In some embodiments, a tester, once added to a beta test, may test an application on multiple devices. In some embodiments, the number of devices may be limited for an account. For example, a testing application and the related account may be used on five devices. Consider the scenario when a user has more than five devices or has lost access to one of the five registered accounts. The tester may want to manage devices tied to the beta test. Accordingly, the testing application may include a device management screen 300, illustrated in FIG. 27, which may be used to remove devices registered to beta test the application program to free up allocations for other testing devices.

During the beta testing process, the tester may receive additional updates or notifications about beta testing application changes. For example, the electronic device may receive and display notifications that an application is a beta-testing-available application. For example, in some embodiments, the electronic device may display beta application program icons or names differently than production applications. For example, the icon may include a dot next to the name of the application. In other embodiments, the icon may have a background or other indication that indicates that the application is beta-testing-available.

The tester may also receive other notifications other than availability of a beta test application. For example, the tester may receive notifications of awards that may be available for achieving various levels of testing. For example, a developer may decide to give in-application rewards or application program discounts or giveaways. For example, the developer may award in-game items that may only be attained via beta testing; the developer may give the application to the tester for free once a predetermined level of testing has been performed or a predetermined amount of productive feedback has been sent by the beta tester; or the developer may set other rewards for beta testing the application that may incentivize the beta testers to test applications. In some embodiments, the notifications may be sent before or after the award has been earned. These notifications of these awards or leaderboards may be made available to the tester via notifications, such email, text messages, application push notifications, operating system notifications, or other suitable notification methods.

### Server Implementation

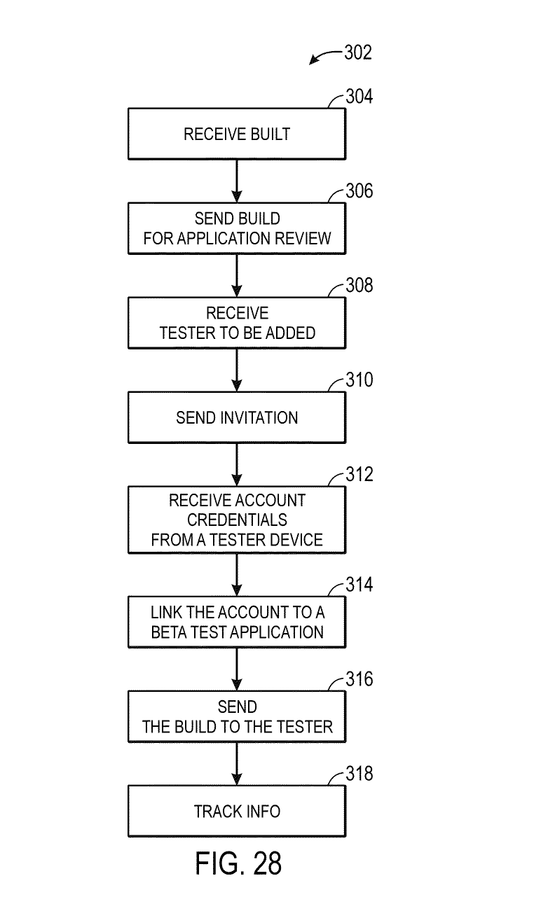

The simplified beta testing and internal testing scheme discussed herein may be implemented using one or more servers, such as the servers 46. FIG. 28 illustrates a process 302 that may be employed using one or more servers. For example, the servers 46 may store instructions in one or more tangible, non-transitory, computer-readable media when executed using one or more processors cause the servers 46 to perform the process 302. In some embodiments, multiple servers may execute the process 302, and these servers may be locally interconnected at a single location in a local area network or remotely interconnected through one or more wide area networks (e.g., the Internet 44). The servers 46 receive a build of an application program to be beta tested (block 304). In certain embodiments, the servers may extract metadata information from the build. For example, the servers 46 may extract an application name, developer name, application description, and/or other information that may be stored in the build. In certain embodiments, the servers 46 mark the build as a beta tested application. For example, the servers may store a name value pair (e.g., “isbeta=yes”) that indicates that the application is a beta tested application. The servers 46 may treat beta tested applications differently than production applications. For example, the servers 46 may send a digest of crash information for a production application periodically, but the servers 46 may send crash information for a beta tested application immediately or more frequently than production application crash reports.

Furthermore, in some embodiments, the servers 46 may track, manage, send, control, and/or store beta applications using a beta test store and track, manage, send, control, and/or store production applications using a production store. Indeed, in some embodiments, the production store and the beta test store may be stored and implemented using different portions of the servers 46. For example, in some embodiments, the production store may run on a first subset of the servers 46 while the beta test store runs on a second subset of the servers 46. Thus, in such embodiments, the production store and the beta test store are partitioned from each other.

In embodiments, where a new build is to be approved through an application review before testing, the servers 46 may send the build for an application review (block 306). For example, the build may be sent to another server or digitally sent to an appropriate application review organization. For example, the build to be tested may be sent to an application review committee based on a function type of the application program to be tested. In other embodiments, the servers 46 may “send” the application program to a code check that determined whether detrimental code exists in the application program. For example, the code check may check for viruses, malware, memory leaks, infinite loops, and/or other code that may cause the application program to behave in a manner detrimental to an executing device. In some embodiments, at least a portion of the code check may be an automated code scan or execution.

The servers 46 also receive contact information for testers to be added to the testing program (block 308). In certain embodiments, the testers may be added before receiving the build. In such embodiments, when a new build has been uploaded and/or approved, the servers 46 may notify currently added testers of previous builds of the availability of the beta test or updated build. In other embodiments, the build may be uploaded prior to the addition of testers.

In embodiments where the build is subject to an application review, the beta testing process may be halted from proceeding to sending invitations until the application program has been reviewed. Once the servers 46 have determined that the beta testing process is ready to advance, the servers 46 may send beta test invitations to added testers (block 310). As previously discussed, the invitations may include a link that may be selected by the tester that opens a request for account credentials from the tester. Furthermore, the invitations may be for a limited period of time (e.g., 30 days) that may be used as a “try before buy” that enables the tester to demo the application before purchasing the application. Furthermore, a person or organization considering acquiring rights to the application program may beta test the application prior to buying and/or transferring the application program management to the transferee.

The servers 46 receive account credentials from the tester (block 312). For example, the servers 46 may receive biometric or login information for an account with the servers. Thus, as previously discussed, the tester may send the login information to the servers without sharing the login information with the developer. In some embodiments, the account credentials may be used to create a new account with the servers 46. Using the received account credentials, the servers 46 may link the account associated with the credentials to the beta test application (block 314). In some embodiments, the servers 46 may acquire a directory services identification (DSID) cryptography key or unique device identifier (UDID) of the tester's electronic device to create or add to a current beta account that is linked to the account associated with the credentials. The servers 46 may use the beta account to create a sandbox environment that enables the tester to fully test the beta tested application, as previously discussed. The DSID cryptography key is linked to the sandboxed beta account. In some embodiments, using the sandboxed beta account, the tester may acquire in-app purchases or beta applications without paying a fee through the sandboxed account even though a similar action through the account associated with the credentials would have a monetary cost. In some embodiments, the sandboxed beta account may be used with a limited number of devices (e.g., 5).

After creation or association of a beta account with a beta tested application, the servers 46 send the build to an electronic device of a tester (block 316). As part of the sending and install process, a developer-signed provisioning profile is created for the device upon which the application is being installed. Thus, the provisioning profile is device-specific and paired with the beta tested application. In some embodiments, the profile has a limited period of time (e.g., 30 days) for the pairing of the device with the beta tested application. In some embodiments, the build may be encrypted, and the servers 46 provide a key that provides the tester access to the application. However, in certain embodiments, the developer and/or the servers 46 may exert some control over the key as digital rights management. For example, the developer may choose to remove the tester from their approved beta testers, and the servers 46 may revoke the key such that the tester no longer has access to the tested application even if the provisioning profile has not expired.

During beta testing, the servers 46 track information about the beta tested application (block 318). For example, the servers 46 may track the number of times that the beta tested application how often the beta tested application has been opened or executed. The servers 46 may also track a number of crashes for the beta tested application. The servers 46 may also track testing for each user, and use the information to determine whether each user has qualified for incentives, such as free production applications or in-app purchases. Once these incentives have been earned, the servers 46 may send suitable promo codes or links to the tester for redeeming the incentives.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A tangible, non-transitory, computer-readable medium storing instructions configured to be executed by a processor to cause the processor to:
receive an invitation to beta test an application program;
receive an indication of a selection of a link in the invitation, wherein the link is configured to initiate a testing application;
request account information through the testing application;
receive account information through the testing application; and
download the application program via the testing application.

2. The tangible, non-transitory, computer-readable medium of claim 1, wherein the account information pertains to an account configured to enable the tester to purchase media from a distribution organization.

3. The tangible, non-transitory, computer-readable medium of claim 2, wherein the instructions are configured to cause the processor to download the application program using a sandboxed beta account that is linked to the account.

4. The tangible, non-transitory, computer-readable medium of claim 1, wherein invitation is received via email, text message, or a device to device communication link between a tester device and a developer device.

5. The tangible, non-transitory, computer-readable medium of claim 1, wherein the processor is configured to receive feedback and transmit feedback to a developer.

6. The tangible, non-transitory, computer-readable medium of claim 5, wherein the feedback is received via the testing application or the application program.

7. The tangible, non-transitory, computer-readable medium of claim 5, wherein the feedback is transmitted via a messaging session between the processor and a developer device.

8. An electronic device comprising:
a network interface;
a processor configured to execute instructions;
one or more tangible, non-transitory, computer-readable medium configured to store the instructions, wherein the instructions, when executed, are configured to cause the processor to:
receive, via the network interface, an invitation to test an application program;
receive an indication of a selection of a link in the invitation;
request account information via a testing application; and
install the application program via the testing application.

9. The electronic device of claim 8, wherein the electronic device is a beta tester device, and wherein the instructions are configured to cause the processor to send a device specific identifier in response to the received indication of the selection of the link.

10. The electronic device of claim 8 comprising a display, wherein the display is configured to display an icon for the application program with a visual indication that the application program is a beta test version of the application program.

11. The electronic device of claim 8, wherein the instructions are configured to cause the processor to receive an indication of a reward for a predetermined duration of testing.

12. The electronic device of claim 8, wherein the instructions are configured to cause the processor to receive an indication of a reward for a predetermined amount of feedback provided to the developer.

13. The electronic device of claim 8, wherein the instructions are configured to cause the processor to receive, via the network interface, a decryption key, wherein the processor is configure to install an encrypted version of the testing application that uses the decryption key to initiate the encrypted version of the testing application.

14. An electronic device comprising:
a processor configured to execute instructions;
one or more tangible, non-transitory, computer-readable medium configured to store the instructions, wherein the instructions, when executed, are configured to cause the processor to:
receive an indication of internal testers for an application program; and
receive an indication of a beta tester to be added to beta test for a build of the application program, wherein the indication includes contact information for the beta tester other than account information for the beta tester for a distribution organization used to distribute the application program or device specific identification information;
view and manage progress of the beta tester in beta testing the build.

15. The electronic device of claim 14, wherein the instructions are configured to cause the processor to receive an indication of at least one predetermined levels of testing or feedback above which rewards are to be awarded to the beta tester.

16. The electronic device of claim 15, wherein the rewards comprise reduced prices on application programs or in-app purchases.

17. The electronic device of claim 14, wherein the instructions are configured to cause the processor to receive and display notifications of changes to beta tester status.

18. A method comprising:
receiving an invitation from a developer, via an electronic device, to beta test a beta version of an application program as a trial period before purchasing a production version of the application program;
sending, via a testing application, account information and a device specific identifier to enable a remote server to link the device with the beta version of the application program; and
receiving, at an electronic device, the beta test version of an application program with a limited duration before the beta version becomes inaccessible.

19. The method of claim 18, wherein receiving the beta test version comprises receiving respective beta versions of the application program at two or more electronic devices, wherein a number of electronic devices is limited by a device threshold.

20. A system comprising:
one or more network interfaces;
one or more processors configured to execute instructions;
one or more tangible, non-transitory, computer-readable medium configured to store instructions, wherein the instructions, when executed, are configured to cause the processor to:
receive, from a developer device via the one or more network interfaces, a build for an application program to undergo beta testing;
receive an indication of a beta tester to be added to the beta testing, wherein the indication comprises contact information for the beta tester;
send an invitation to the beta tester using the contact information;
receive account information for an account, from a beta testing device via the one or more network interfaces, in response to the invitation;
acquire a device specific identifier from the beta testing device; and
link a beta testing account to the beta testing device.

21. The system of claim 20, wherein the instructions to cause the processor to link the beta testing account to the beta testing device comprise instructions to create a sandboxed beta testing account that is partitioned from the account.

22. The system of claim 21, wherein the instructions are configured to cause the one or more processors to send a beta tested version of the application program without cost via the sandboxed beta testing account and to send a production version of the application program with a fee.

23. The system of claim 20, wherein the instructions are configured to cause the one or more processors to:
send an encrypted beta tested version of the application program; and
send a decryption key to the beta testing device.

24. The system of claim 23, wherein the instructions are configured to cause the one or more processors to revoke the decryption key to block the beta testing device from accessing the encrypted beta version of the application program.

25. The system of claim 20, wherein the instructions are configured to cause the one or more processor to send crash reports for a beta test version of the application program more frequently than crash reports for a production version of the application program.
